(19) United States
(12) Patent Application Publication
(10) Pub. No.: US 2002/0098307 A1
(43) Pub. Date: Jul. 25, 2002

(54) Material useable for medical balloons and catheters

(76) Inventors: Robert S. Schwartz, Rochester, MN (US); Robert A. Van Tassel, Excelsior, MN (US); Gregory G. Brucker, Minneapolis, MN (US); Skott Greenhalgh, Glenside, PA (US)

Correspondence Address: James W. Inskeep, Oppenheimer Wolff & Donnelly LLP, Suite 700, 840 Newport Center Drive, Newport Beach, CA, 92660, US

(21) Appl. No.: 09/974,220

(22) Filed: Oct. 9, 2001

Related U.S. Application Data
(60) Provisional application No. 60/238,957, filed on Oct. 9, 2000.

(51) Int. Cl. B32B 1/08

(52) U.S. Cl. 428/36.3

(57) ABSTRACT

A device and method for making medical balloons such as for angioplasty. The device has fibers that may be of different materials, shapes, sizes, and directions, with the interstitium filled by a polymer materials to render it waterproof and able to be pressurized. The device exhibits improved strength and flexibility. Preferably, the device is steerable, radiopaque, and can operate at very high inflation pressures in order to facilitate low impedance angioplasty.

### CROSS REFERENCE TO RELATED APPLICATIONS

This application claims priority from U.S. Provisional Application Serial No. 60/238,957 filed Oct. 9, 2000, entitled A NOVEL METHOD OF CATHETER FABRICATION AND A NOVEL METHOD OF MEDICAL BALLOON FABRICATION.

### BACKGROUND OF THE INVENTION

The field of the invention includes materials suitable for use in making medical balloons and catheters, such as for angioplasty. Current angioplasty balloons are fabricated from polymer sheets, and are thus isotropic. The material exhibits no differential properties of elasticity or mechanical compliance as a function of bend direction. Anisotropic balloon characteristics must thus be attained through variations in material thickness, layering, and the like, such as is the case with biaxially oriented balloons.

There are several features of current balloons that represent areas for improvement. Current balloon devices do not typically exhibit the flexibility optimal for delivery, with or without a stent, to lesion sites targeted for angioplasty. In the case of coronary angioplasty, for example, the delivery path is usually very tortuous, requiring significant bending of the device to reach the target site.

Another problem associated with current balloons pertains to balloon compliance. When a balloon is being used for stent delivery, compliance of those portions of the balloon that protrude past the ends of the stent is thought to be responsible for vessel injury and further predisposes the artery for neointimal formation as a result of the injury done by the balloon. The balloon inflates uniformly until the stent reaches a maximum diameter. Continued inflation results in compliant expansion of those portions of the balloon that extend beyond the stent while the portion of the balloon constrained by the stent can no longer comply with the increased fluid volume. A shape, similar to a dog bone, results with compliant bulging past either end of the stent. This bulging creates unhealthy stresses in the walls of the vessel being treated, typically resulting in significant injury to the vessel wall. A balloon with lower radial compliance is needed as a stent delivery device, both in coronary and peripheral vessels. Preferably, the balloon would exhibit self-restraining qualities regardless of whether a stent surrounds the balloon. A balloon that is appropriately compliant, yet capable of very high pressures, (equal to or greater than 40 atmospheres) would permit appropriate stent expansion, yet minimal “dog boning” effects as the stent cannot resist such high balloon pressures.

### BRIEF SUMMARY OF THE INVENTION

The present invention pertains generally to a fiber-based membrane for use in a medical balloon or catheter. The fibers are preferably woven or braided. Fiber directions and numbers are chosen to create an anisotropic material. As opposed to current polymer membranes of angioplasty balloons, which are isotropic, that is, the elasticity is uniform for all directions of stress and tension within the polymer, the anisotropic material of the present invention provides compliance only in chosen directions.

For example, an anisotropic structure may have vertical members of a strong, inelastic material, while the cross members may be of a different, more compliant material. One aspect of the invention provides that one of the materials is metallic, such as approved stainless steel. The fibers are sealed, or otherwise contained, within a thin polymer coating that makes them yield a differential expandability. Preferably, one or more of the fibers is radiopaque.

Importantly, if the fibers are made to run circumferentially, the fibers will impart increased radial strength to the device, encouraging the device to expand longitudinally when pressurized. This will provide longitudinal compliance coupled with reduced radial compliance, thereby creating an anisotropic expansion characteristic which minimizes the potential for imparting damage to the vessel walls during introduction. Moreover, if the balloon having circumferential fibers is elongate, so as to form a cylinder, longitudinal flexibility is preserved. If the existence of the fibers allows a membrane to be used that is thinner than would be required in the absence of the fibers, longitudinal flexibility may even be increased.

The circular symmetry of the present invention results in a balloon having excellent trackability, in a deflated state, because the longitudinal compliance allows it to snake around corners. If a spiral pattern is used to arrange the fibers around the circumference of the balloon, varying the pitch of the spiral provides different degrees of inflated and deflated longitudinal compliance.

In order to provide a fluid-tight surface, a polymer is placed within the interstices of the spiraled support fibers or coils. The polymer may be a different material than that of the support coils. The polymer may be a polymer film, formed between the fibers to make the balloon fluid-tight and able to hold pressurized or non-compressible fluids.

The fibers of the balloon, in addition to providing radial rigidity and preserving longitudinal compliance, may be used to further control the expansion characteristics of the balloon during inflation, more specifically, predetermined, incremental balloon sizes may be obtained. This will allow one balloon size (pre-inflation) to serve a variety of applications requiring different inflation sizes. For example, one balloon-stent may be useful for the 3.0-4.0 mm size range. Typically, three balloon sizes are used to cover this range: 3.0, 3.5, and 4.0 mm. The present invention replaces this with one balloon which can be selectively inflated to each of these diameters. An initial inflation brings the balloon to 3.0 mm in diameter. Overcoming a first pressure threshold causes an incremental increase in the diameter of the support coil, thus “stepping” the diameter of the inflated balloon up to 3.5 mm. A second pressure threshold, once reached, again allows the diameter of the inflated balloon to step up, this time to 4.0 mm. This feature eliminates the need for stepwise balloon sizing, thus reducing the quantity of balloons stocked in a catheter lab by two-thirds. Numerous sizes can be devised using a wide range of pressure thresholds.

Another aspect of the present invention provides a balloon material having a plurality of elongate, hollow fibers running longitudinally down the length of the balloon. The proximal ends of the fibers are fluidly connectable to a fluid pressure source. They may be connected to the fluid pressure source such that the fibers are selectively in fluid communication with the source, or such that each fiber is connected to a different pressure source. The fibers may thus be selectively inflated, thereby causing the balloon to bend around corners when fibers on one side of the balloon are inflated more than those on the other side. These hollow fibers are also useable in a catheter to similarly steer the catheter using selective inflation techniques. Incorporating radiopaque fibers allows an attending physician a viewing aid for steering the balloon or catheter. This bending aspect allows a balloon or catheter to bend through a tight curve having a very small radius, and may be particularly useful for steering a guidewire into difficult to reach, arterial locations. If the device is made to retroflex, it can easily guide a wire into a sidebranch. A three chambered system is preferably used to provide the ability to steer the device in any direction. Differential pressurization of the septa will cause the balloon to bend through a tight radius of curvature as well. The fibers in this design can be elastic and biased at a predetermined level so that the balloon can bend in any direction.

Yet another aspect of the present invention pertains to the balloon's unique ability to withstand high pressures. The high pressure expansion characteristic made possible by the fibers allows the balloon to be expanded using either high or low pressures. During standard dilatations and stent expansions, if a stent is expanded at 8 atmospheres of pressure, resistance to expansion by a lesion being treated may demand a higher internal balloon pressure, and the external force which arises when this demand is answered creates a dog bone effect as the balloon on either sides of the lesion expands more than that part of the balloon adjacent the lesion, thereby giving the balloon a relative constriction or “waist” at the point of artery or stent location. Increasing the balloon pressure will generally break the resistance to allow additional radial expansion. Conversely, if the balloon is expanded under high balloon tension (high pressure) the device will not dog-bone or form a waist. Referring to the resistive force exhibited by the artery or stent as “expansion-impedance” (I), a relationship between the expansion-impedance, the radial expansion (E) and the tension in the balloon (T) can be represented as:

$$I ∝ \frac{E}{T}$$

such that when the expansion occurs under high pressure, the impedance is quite low. Expanding a stent or dilating an artery (or both simultaneously) is facilitated by this low impedance expansion since, as the balloon is loaded by the resistive force of the stent or artery, it expands without being impeded and achieves a more uniform expansion.

In addition to the aforementioned expansion advantages that the use of fibers provide, it is envisioned that the fibers may be constructed and arranged to form a device, such as a filter or cage, at the distal tip of the balloon. The distal device can be used to manage the particulate matter, such as arterial plaque, dislodged from the walls of the vessel during expansion. A filter, for example, can be used to prevent the particulate matter from entering the catheter when the catheter is being used in a suction capacity. A cage can be fashioned to trap and extract the particulate matter when the catheter is removed.

Using the fiber technology of the present invention to form catheters allows a catheter to be formed having segments of varying flexibility. Flexibility may be varied by changing the weave pattern of the fibers. For example, a circumferentially spiraling fiber may extend down the length of the catheter, interwoven with uniformly spaced longitudinal fibers. Increasing the pitch of the circumferential fiber decreases the weave density and, thus, increases the flexibility. Thus, a catheter could be formed with such a circumferential fiber having segments of increased and decreased pitch to create desired segments of varying flexibility. For example, a coronary catheter could be fashioned having a relatively stiff proximal end, thereby permitting good torque transmission for straightening tortuous vessels. The catheter could also have a relatively soft tip curves to avoid arterial injury. Portions of the tip may be stiffer than others to permit guide support.

Portions of the catheter could also be provided with varying characteristics by altering the thickness of the interstitial polymer or even varying the types of polymer used along the length. For example, the catheter may provide a segment in which the woven fibers are uncoated or weakly coated with the polymer in order to provide a segment that allows fluid to escape from the lumen in a controlled manner, such as may be desired with the introduction of a contrast agent.

The fibers can be woven or braided in a fashion to change the shape of the balloon from a cylinder to a tapered cylinder. The fibers could be woven to make the shape of the balloon oval, wedge like, dog bone, reverse taper, and so on. Two balloons could be made from one piece of fabric to create a unique shape with balloons side by side.

### BRIEF DESCRIPTION OF THE DRAWINGS

FIG. 1 is a graph generally depicting compliant inflation behavior;

FIG. 2 is a graph generally depicting the expansion behavior of the device of the present invention when filled with a compressible fluid;

FIG. 3 is a graph generally depicting the expansion behavior of the device of the present invention when filled with an incompressible fluid;

FIG. 4 is a graph generally depicting the expansion behavior of an embodiment of the device of the present invention whereby no compliant behavior is exhibited;

FIG. 5 is a side elevation view of a pleated balloon embodiment of the present invention;

FIG. 6 is a plan view of the embodiment of FIG. 5;

FIG. 7 is a partially inflated side elevation view of the embodiment of FIG. 5;

FIG. 8 is a perspective view of a fabric sleeve balloon of the present invention;

FIG. 9 is a plan view of the fabric sleeve balloon of FIG. 8;

FIG. 10 is a perspective view of the fabric sleeve balloon of FIG. 8 in a partially inflated state;

FIG. 11 is a top plan view of an alternative embodiment of the fabric sleeve balloon of the present invention;

FIG. 12 is a perspective view of a fill yarn critical sleeve embodiment of the present invention inflated to a first diameter;

FIG. 13 is a perspective view of the fill yarn critical sleeve of FIG. 12 inflated to a second diameter;

FIG. 14 is a perspective view of a section of material useable to make a balloon of the present invention which inflates to multiple, distinct diameters;

FIG. 15 is a perspective view of a section of material useable to make a balloon of the present invention which inflates to multiple, distinct diameters;

FIG. 16 is a section view of a thread pattern useable to create a material of the present invention which exhibits anisotropic stretching characteristics;

FIG. 17 is a perspective section view of a catheter of the present invention;

FIG. 18 is a perspective view of an alternative catheter of the present invention;

FIG. 19 is a perspective view of a segment of material usable to form a catheter having a weeping effect;

FIG. 20 is a perspective view of an embodiment of a balloon of the present invention whereby the fibers are constructed and arranged to form a filter external to the balloon; and,

FIG. 21 is a perspective view of an embodiment of a balloon of the present invention whereby the fibers are constructed and arranged to form a cage external to the distal end of the balloon.

### DETAILED DESCRIPTION OF THE INVENTION

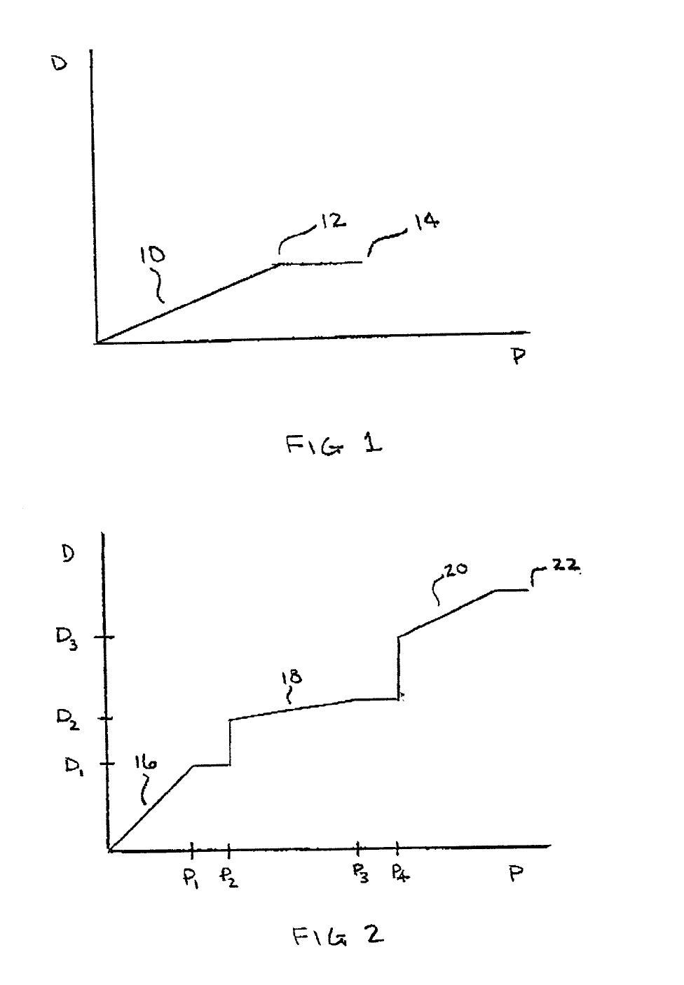

Conventional angioplasty balloons may be described as “compliant”, meaning that the diameter of the inflated balloon is directly proportional to the inflation pressure over a defined pressure range. This behavior is illustrated in FIG. 1, which shows a graph of balloon diameter “D” versus inflation pressure “P” for a typical compliant angioplasty balloon. The plot displays a linear region 10 which describes the compliant aspect of the balloon where there is a direct proportional relation between the diameter and the inflation pressure. The graph is continuous indicating that the balloon diameter increases or decreases in a continuous manner as a function of the inflation pressure. There is a point, however, where the elastic limit of the material comprising the balloon is exceeded and the balloon increases unpredictably, usually significantly in diameter in proportion to a further increase in the pressure. The elastic limit is indicated at point 12 which marks the end of linear behavior of the balloon. The pressure may be increased further, but a point is eventually reached where the ultimate strength of the balloon material is exceeded and the balloon bursts as indicated at point 14.

The invention concerns balloons useful in angioplasty procedures, as well as for other purposes. The balloons, according to a first aspect of the invention, have a plurality of pressure ranges over which compliant behavior is manifest (i.e., the diameter is substantially linearly proportional to the inflation pressure), the ranges of compliant behavior being separated by points wherein the diameter increases in a discontinuous jump between a relatively smaller diameter and a relatively larger diameter such that the behavior of the balloon over its entire useful pressure range may be described as “non-compliant”. In a second aspect of the invention the balloon diameter jumps substantially discontinuously between discrete diameters with increases in inflation pressure without any significant compliant behavior of the balloon between the various diameters.

FIG. 2 presents a graph which generally illustrates the “non-compliant” behavior of balloons according to the first aspect of the invention. The graph shows the balloon diameter “D” as a function of inflation pressure “P”. Such balloons may initially exhibit compliant behavior as shown in the linear region 16 up to a first predetermined pressure P1 corresponding to a maximum diameter D1. Increase in pressure P beyond P1 does not result in an increase in diameter D of the balloon until a second predetermined pressure P2 is reached. If the balloon is pressurized with a gaseous fluid, the balloon diameter jumps discontinuously to a relatively larger diameter D2 once the predetermined pressure P2 is reached. Further, increasing the pressure P beyond P1 need not be accompanied by an increase in the length of the balloon as gaseous fluid may be compressed. The balloon behavior may then again be compliant between P2 and a third predetermined pressure P3 as evidenced by the linear region 18 of the graph. At and above P3, there will again be no significant increase in balloon diameter as the pressure is increased until a fourth predetermined pressure P4 is reached. At P4, the diameter of the balloon will jump discontinuously to a larger diameter D3 and then behave compliantly over a further range of pressures above P4 as indicated at 20. These characteristics featuring regions of compliant behavior separated by discrete, discontinuous jumps in diameter can be repeated but eventually practical considerations will place a limit on the behavior and the balloon will eventually reach the end of its ability to stretch and burst when the balloon's ultimate strength is exceeded, as indicated at 22. It is noted that the graphs shown are representative of general principles for explanatory purposes only.

If a liquid fluid is used to pressurize the balloon, there will not be significant abrupt jumps in balloon diameter at the transition points between the regions of compliant behavior. This is due mainly to the fact that liquids tend to be substantially incompressible and the increases in pressure within the balloon are hydraulically transmitted through the liquid without significant amounts of additional liquid entering the balloon. Once the critical pressure marking the transition point is exceeded, however, and the balloon is free to expand further, the balloon may be inflated to a larger diameter in a controlled manner by forcing more liquid into it. Use of liquid to inflate the balloon, thus, prevents the balloon from suddenly expanding at a transition point and causing an injury or a rupture in a blood vessel, for example. FIG. 3 is a graph showing the behavior of a liquid filled balloon. There is a relatively small jump 24 in the balloon diameter at point P2 between the ranges of linear behavior 16 and 18. Notably, this small jump 24 in balloon diameter may be accompanied by a small decrease in pressure until fluid is introduced to the newly created space resulting from the increase in balloon diameter.

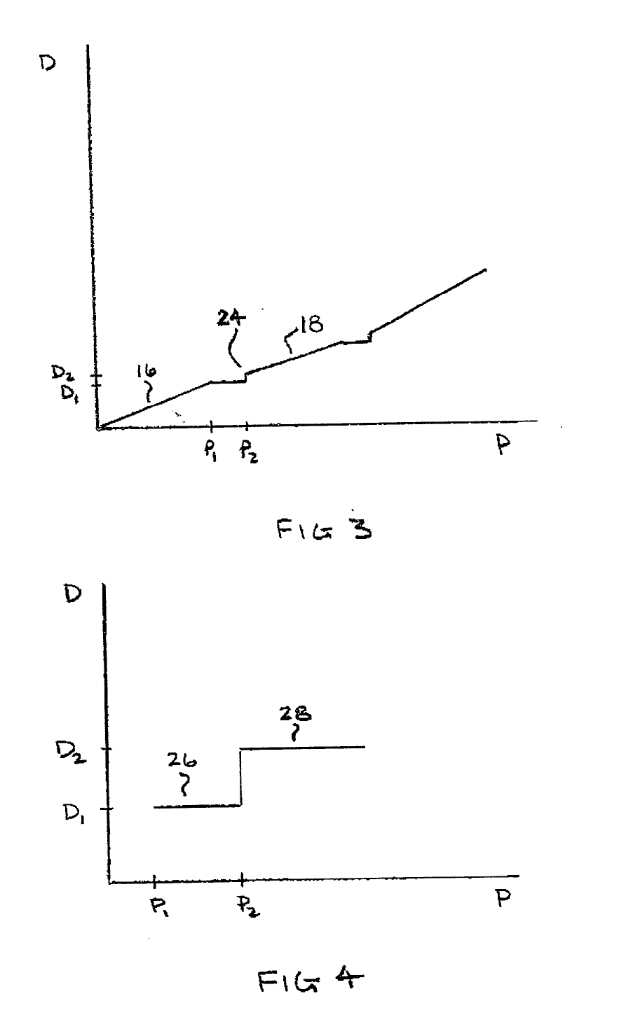

FIG. 4 illustrates the behavior of a balloon according to the second aspect of the invention. For such balloons, there is a first diameter D1 which the balloon achieves over a relatively large pressure range 26 and a second diameter D2 achieved over another pressure range 28, but there are no regions of compliant behavior where the balloon diameter is continuously variable as a function of the inflation pressure. Various balloon embodiments corresponding to both aspects of the invention are described in detail below.

The pleated balloon 30 shown in FIGS. 5 through 7 has an envelope 32 preferably comprised of a flexible, resilient, elastic material such as rubber or similar synthetic polymer. A plurality of pleats 34 are formed in the envelope by folding it, preferably inwardly in a series of reverse folds 36 as shown in FIG. 6. Reverse folds 36 have facing portions 38 and 40 which are releasably adhered to one another, for example, by an adhesive layer 42, which will hold the pleats together until a predetermined critical pressure is achieved within the balloon.

The balloon with pleats 34 initially displays compliant behavior, expanding linearly or otherwise proportionally with increasing inflation pressure until the predetermined critical pressure is reached. Pressure within the balloon places the pleats under tension and the adhesive releases the pleats at the predetermined critical pressure to allow the balloon to abruptly expand from a first diameter D1 shown in FIG. 5, to a second, larger diameter D2 shown in FIG. 7. Note that not all of the pleats 34 have released at the critical pressure. It is possible to arrange for different pleats to release at different internal pressures, thus, allowing the balloon to have multiple compliant behavior regimes separated by multiple discrete jumps in diameter. Release pressures for the pleats may be controlled, for example, by using several adhesives having different strengths to secure different pleats. Pleats secured with a relatively weak adhesive will separate at a lower pressure than pleats secured with a stronger adhesive. It is also possible to control the release pressure by using the same adhesive on all pleats but forming the adhesive bond over a relatively larger surface area between the facing portion 38 and 40 of the pleat when a stronger bond, corresponding to a higher critical pressure, is desired.

Pleats 34 may also be secured by other means including ultrasonic bonding and thermal bonding. The envelope 32 may alternately be comprised of materials such as polyurethane, PET, Silicone, nylon, or acrylic, to name a few. When resilient elastic material is used for the envelope, the pleated balloon behaves according to the first aspect of the invention with expansion characteristics as shown in FIG. 2.

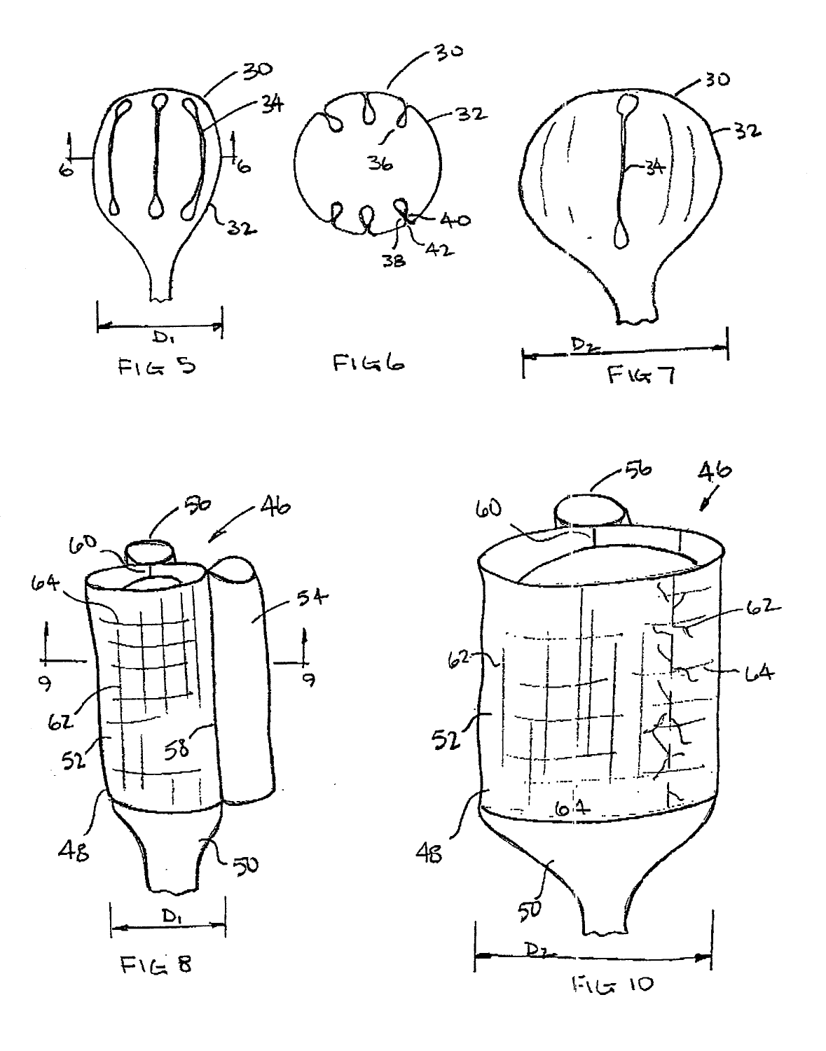

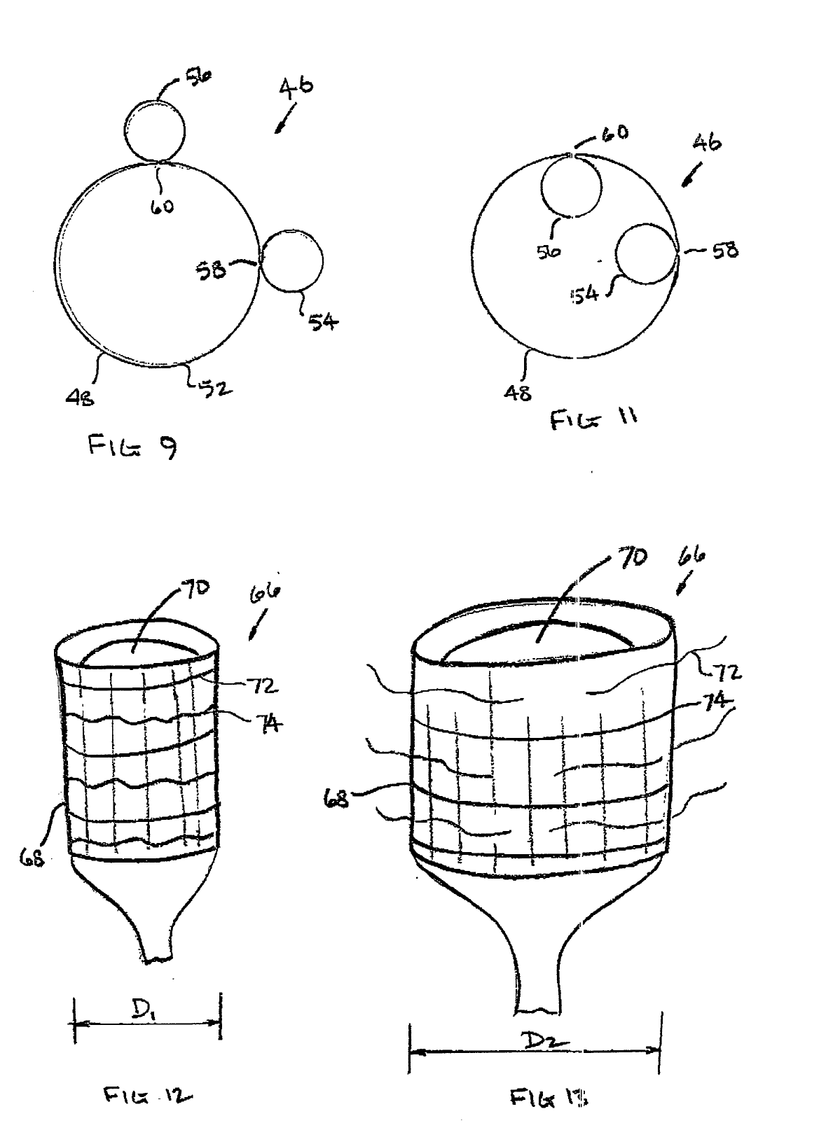

FIGS. 8-11 show a fabric sleeve balloon 46. This embodiment has fabric sleeve 48, preferably woven and comprised of polymer yarns, fibers or monofilaments of materials such as polyester, polypropylene, or nylon, as well as liquid crystal polymers such as Spectra, PBO zylon, Vectran. Although of woven construction, the sleeve 48 may itself have a coating or film of resin, silicone or polyurethane causing it to be fluid tight, or it may enshroud a fluid tight membrane 50 as depicted in FIG. 8.

Sleeve 48 is formed preferably by arranging a single woven tube having a relatively large diameter into a plurality of smaller diameter tubes, three tubes numbered 52, 54 and 56 being shown by way of example. The tubes are arranged substantially parallel to each other and each is separated from another by a respective rip-stop seam 58 and 60. One of the tubes, 52, is inflatable and, when pressurized, places tension forces on the rip-stop seams 58 and 60 between tube 52 and tubes 54 and 56 respectively. Seams 58 and 60 are designed to release when a predetermined tension force corresponding to a predetermined pressure within tube 52 is reached. The release force may be different for each seam.

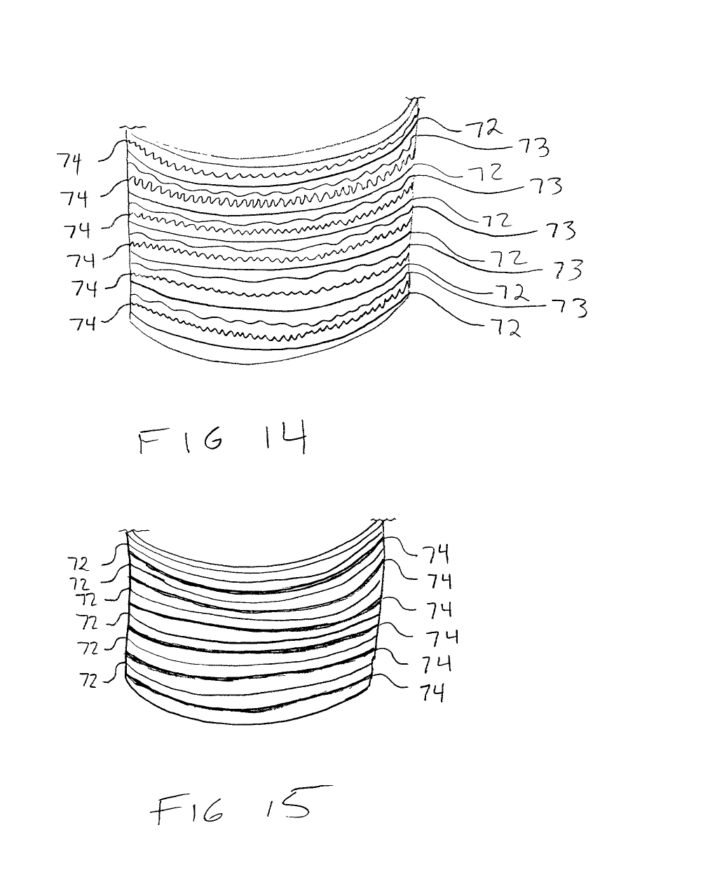

The fabric sleeve balloon 46 may be inflated to a first diameter D1 shown in FIG. 8 and remain at that diameter while the inflation pressure is increased until a first predetermined critical pressure is reached, at which point the tension forces on the seam 58 exceed the strength of the seam and the seam parts allowing the fabric sleeve balloon to expand in a discrete jump to a larger diameter D2 shown in FIG. 10. Note that seam 60, which has a relatively higher strength, is still intact and holds tube 56 in place. When a second predetermined critical pressure is reached, seam 60 will also part and allow the balloon to expand in a discrete jump to another larger diameter.

Seams such as 58 and 60 are formed by weaving together warp fibers or yarns 62 along the length of the seam. Normally during weaving the shuttle carrying the fill yarns 64 moves in a “figure 8” path which causes the warp and fill yarns to cross over one another. However, to create tubes 52, 54 and 56 according to the invention, the shuttle is moved across the top and bottom faces of the tube and does not cross at the seam, resulting in multiple warp fibers being captured by fill fibers or yarns along the seam. The strength of seams 58 and 60 is mainly determined by the strength of the warp yarns, but other parameters such as the number of warp yarns and their denier also affect the seam strength. Separation of the seam is effected by the parting of the warp yarns along the seam, the circumferential yarns remaining intact and maintaining the integrity of the fabric sleeve balloon 46.

The fabric sleeve balloon 46 may exhibit aspects of compliant behavior as illustrated in FIG. 2, or it may be totally non-compliant and jump between diameters exhibiting no significant compliant behavior as shown in FIG. 3. Compliant behavior will occur if elastic resilient yarns are used to form the sleeve 48. This will allow tube 52 to increase in diameter linearly as a function of inflation pressure until the tension forces on a seam exceed the strength of the seam, causing the seam to part and allowing a discontinuous jump to a larger diameter. If the yarns comprising the sleeve are inelastic, then the only significant changes in diameter will occur when the inflation pressure causes seams to part and a discontinuous diameter change results.

While the tubes 54 and 56 are shown positioned on the outside of tube 52, this is for clarity of illustration. It is preferred that the tubes 54 and 56 be arranged on the inside of tube 52 as shown in FIG. 11. The inside configuration allows the balloon to have a regular circular shape so as to pass readily through vessel and catheter lumens.

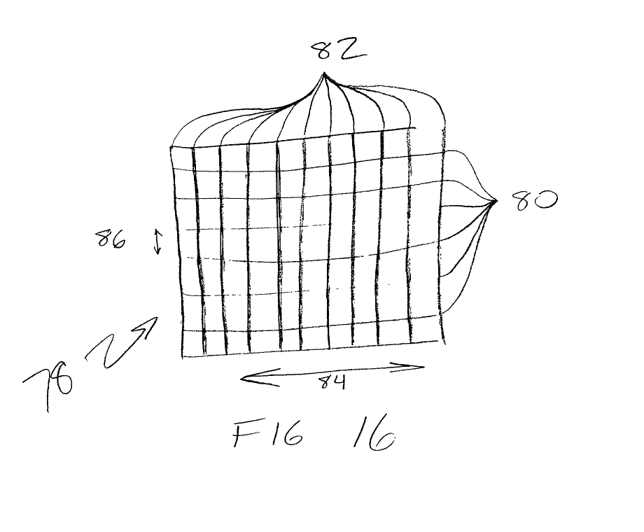

FIGS. 12 and 13 show a fill yarn critical sleeve balloon 66 according to the invention. Balloon 66 comprises a woven sleeve 68 which may itself be fluid tight or may have an inflatable membrane 70 within. Sleeve 68 is woven with circumferential yarns 72 and 74 having different characteristics as described below which allow the balloon 66 to display both compliant and non-compliant behavior.

Preferably, circumferential fill yarns 72 have a first, relatively low tensile strength, and circumferential fill yarns 74 have a relatively higher tensile strength. Furthermore, fill yarns 74 are overfed upon weaving, and thus are longer than fill yarns 72. If fill yarns 72 are elastic, then the balloon 66 will expand continuously when inflated to a maximum first diameter D1 (see FIG. 12) limited by the strength of the fill yarns 72. Increasing the pressure above a predetermined critical value will cause fill yarns 72 to part and the balloon 66 will expand discontinuously to a second diameter D2 (see FIG. 13) established by the length and elasticity of fill yarns 74. Due to their relatively greater length, due to overfeeding, fill yarns 74 do not take any significant load until fill yarns 72 part. If fill yarns 74 are elastic, then the balloon 66 may be further expanded by increasing the inflation pressure. If the fill yarns 74 are relatively inelastic, then the diameter will remain substantially constant with increases in inflation pressure until the tensile strength of the fill yarns 74 is exceeded.

If circumferential yarns 72 and 74 are relatively inelastic, then the balloon 66 will have essentially two discrete diameters determined by the relative lengths of the fill yarns and the balloon will display no significant compliant behavior in between the two discrete diameters.

The relative strengths of the fill yarns 72 and 74 may be controlled by choice of the materials comprising the yarns and their denier, as well as the ratio of number of one type of fill yarn 72 to the other 74 comprising the sleeve 68. Relative elasticity may also be used to establish the critical pressures and discrete diameters defining the non-compliant behavior of the balloon 66. For example, if fill yarns 72 are fully oriented and fill yarns 74 are partially oriented then fill yarns 72 will be relatively inelastic and take the load when the balloon is inflated while fill yarns 74, being relatively elastic, will stretch and not bear any significant load until the inflation pressure is reached where the relatively inelastic fill yarns 72 part and the balloon expands discontinuously until yarns 74 take up the load and resist further expansion of the balloon.

As shown in FIG. 14, this overfeeding approach can be used to create more than one distinct jumps in diameters. Here, fill yarns 73 and 74 have been overfed, thereby each creating somewhat of a sine wave, when compared to relatively straight fibers 72. The “wavelength” of the sine wave of yarns 74 is shorter than that of yarns 73, making yarns 74 longer than the yarns 73. Thus, as the device inflates, a first diameter will be determined by the yarns 72 until they break, the diameter will then jump up to a second diameter, defined by the yarns 73 until they break, at which time the diameter will jump up to a third diameter, defined by the yarns 74.

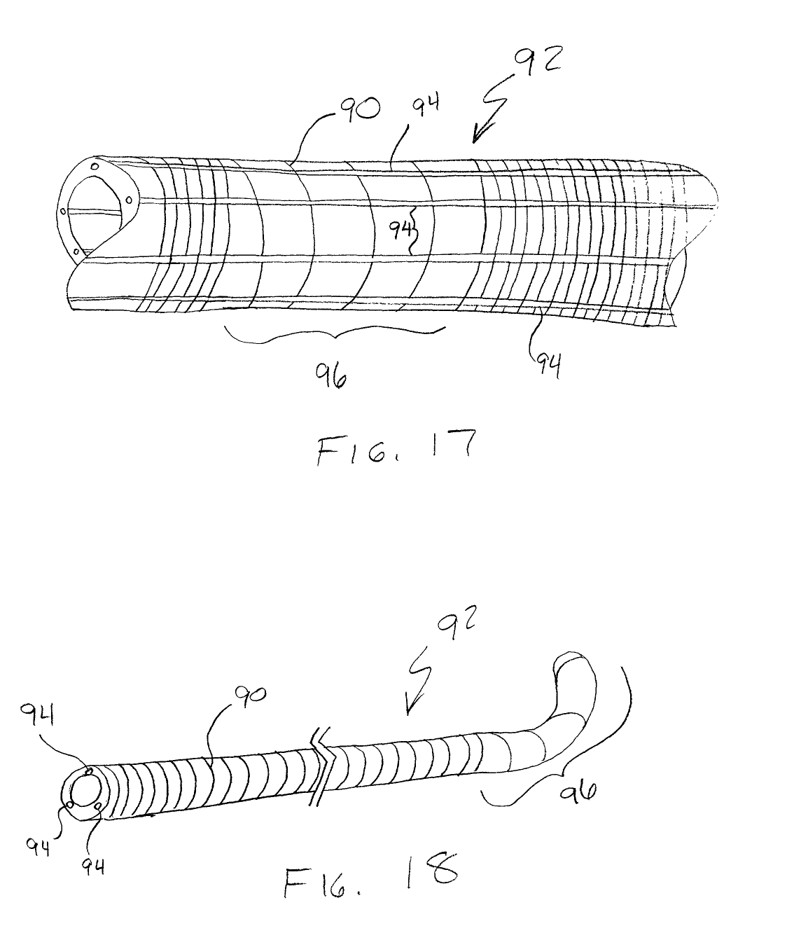

Looking at FIG. 15, it can be seen that this same effect can be obtained using circumferential fibers 72 and 74 which are elastic, rather than inelastic. These elastic fibers have different yield points and thus, break at different pressures and stretched lengths. The fibers 74 are shown as being thicker and, thus, stronger, however it may be desired to provide similarly sized fibers 72 and 74 that attain different elastic profiles because they are made of different materials, as opposed to having different thicknesses.

Preferred materials for the fill yarn critical sleeve balloon include polymer yarns, fibers or monofilaments of materials such as polyester, polypropylene, or nylon, as well as liquid crystal polymers such as Spectra, PBO zylon, Vectran.

The principles of the present invention can be practiced to provide medical devices exhibiting anisotropic stretching characteristics. Anisotropic materials stretch differently in different directions when exposed to a relatively uniform stress, such as when they are being inflated. By providing a balloon that stretches along one direction, but is relatively nondistensible in another direction, many of the problems described in the background can be avoided.

Referring now to FIG. 16, there is shown a section of material 78 having distensible fibers or yarns 80 and nondistensible fibers or yarns 82. Thus the material 78 exhibits elastic properties in a first direction, indicated by arrows 84, but little to no elastic properties in a second direction, indicated by smaller arrows 86.

Using such a material 78 to create a balloon or catheter of the present invention provides control over the expansion characteristics of the device. For example, if the material 78 were used to create a balloon, and oriented such that the distensible fibers 80 run longitudinally, while the nondistensible fibers run circumferentially, a balloon is created which can expand in length but maintains a relatively constant radius. This balloon avoids the dog-boning problems of the prior art.

Notably, if the elastic membrane 88 used to make the balloon fluid-tight is strong enough for its intended purpose, and the circumferential fibers 82 are impregnated into, or otherwise securely fastened to the balloon membrane 88, it may be unnecessary to provide the longitudinal fibers 80. However, inclusion of the longitudinal fibers 80 provides more control over the elasticity of the balloon 78 in a given direction and also predictably controls the yield point of the balloon 78. The balloon 78 can thus be inflated rapidly, using higher than usual pressures, such as on the order of 40 atmospheres, thereby overcoming resistance imposed by an area such as a lesion of the vessel being treated, thus expanding uniformly without creating a waist.

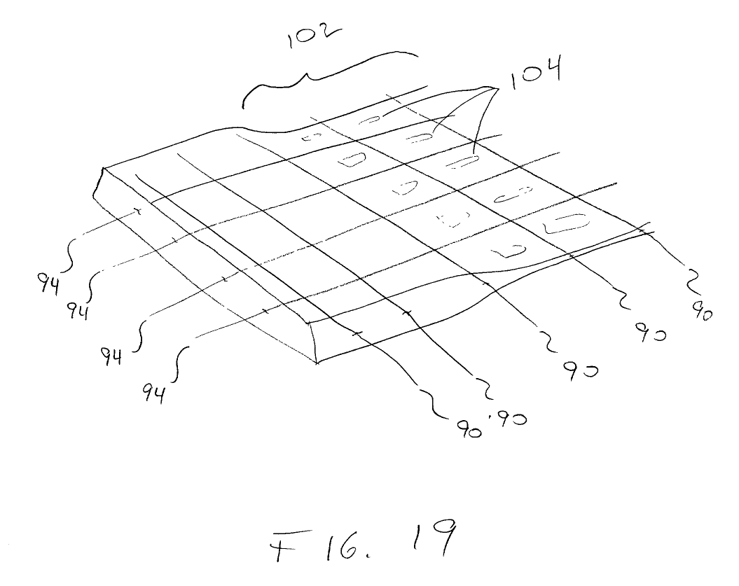

Using the fiber technology of the present invention to form catheters allows a catheter to be formed having segments of varying flexibility. Referring to FIG. 17, it can be seen that flexibility may be varied by changing the weave pattern of the fibers. For example, a circumferentially spiraling fiber 90 may extend down the length of the catheter 92, interwoven with uniformly spaced longitudinal fibers 94. Increasing the pitch of the circumferential fiber 90 decreases the weave density and, thus, increases the flexibility. Thus, a catheter 92 could be formed with such a circumferential fiber 90 having segments of increased pitch 96 to create segments 96 of varying flexibility.

Insofar as fibers 94 are distensible, the catheter can be made to be steerable by using hollow, inflatable fibers 94. When the fibers 94 are inflated, they increase in length. Inflating some of the fibers 94, while leaving others deflated, causes one side of the catheter 92 to become longer than the other side, necessarily bending the catheter in the direction of the fibers 94 that are not inflated.

FIG. 18 shows how the areas of increased flexibility 96 can be combined with the characteristics of the hollow fibers 94 to provide a desired result. The catheter 92 has a spiraling circumferential fiber 90 extending down the length of the catheter 92. The spiraling fiber 90 has an increased pitch at the distal end of the catheter 92 thereby creating a segment of increased flexibility 96. The catheter also has three inflatable fibers 94 imbedded within a membrane 98 making up the body of the catheter. When the inflatable fibers 94 are inflated at different pressures in order to cause the catheter 92 to bend toward the fibers 94 which are least inflated, the catheter 92 will bend more at the segment of increased flexibility 96 because it will experience less resistance to bending at that segment 96. This significantly decreases the radius of the bend and makes the catheter 92 very steerable.

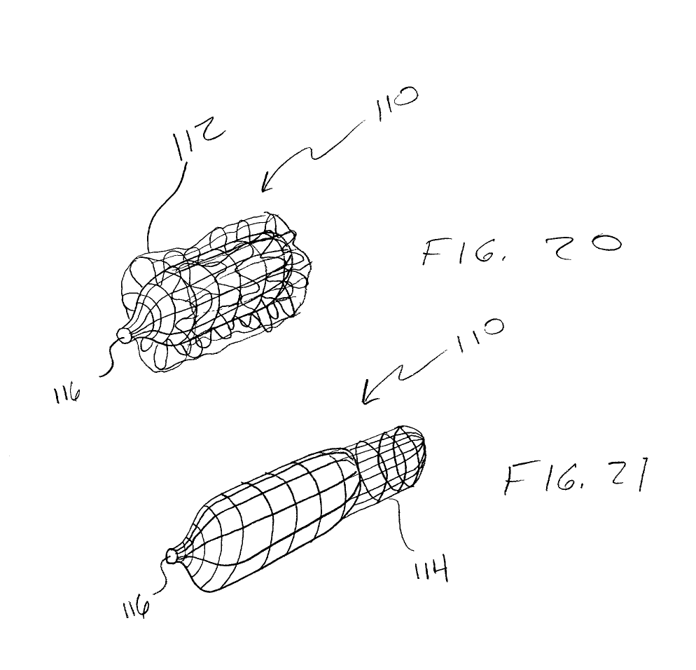

Portions of the catheter 92 could also be provided with varying characteristics by altering the thickness of the interstitial polymer 98 or even varying the types of polymer used along the length. Referring to FIG. 19, a material 100 is shown for use in devising a catheter 92 having a fluid tight body 98 with a weeping section 102. The polymer 98 comprising the body is so thin in section 102 that small holes 104 are created in the interstices of the fibers 90 and 94. These holes 104 allow fluid introduced through the lumen of the catheter 92 to escape into the treated vessel. If the holes 104 are numerous, the pressure of the fluid escaping will be low, thereby creating a weeping effect.

As seen in FIGS. 20 and 21, in addition to the aforementioned expansion advantages that the use of fibers provide, it is envisioned that the fibers may be constructed and arranged to form a device 110, such as a filter 112 or cage 114, at the distal tip of the balloon or catheter. The distal device 110 can be used to manage the particulate matter, such as arterial plaque, dislodged from the walls of the vessel during expansion. A filter, for example, can be used to prevent the particulate matter from entering the catheter when the catheter is being used in a suction capacity. A cage 114 can be fashioned to trap and extract the particulate matter when the catheter is removed. FIG. 20 shows a device 110 comprising a balloon 116 having fibers of the present invention that are woven into and out of the balloon 116 in order to form an external filter 112. FIG. 21 shows a device 110 comprising a balloon 116 wherein the fibers of the present invention extend from the distal end of the balloon 116 to form a cage 114.The fabric we used to make the balloons are woven into near net shape structures. The fabric is woven to resemble a standard angioplasty balloon. The fabric ends are tapered. The advantage of this is that the end balloon cones are not as thick as standard balloons. Furthermore, the shape of the fabric reduces any need for seams or overlapping balloons material.

FIG. 20 shows a device 110 whereby the fibers of the balloon extend radially to form a filter 112. Fibers thus raised from the surface, either completely or just partially, may also serve other purposes. For example, textured balloon surfaces can be made by covering the inside of the fabric only. In other words, the membrane is attached to the inside of the mesh, leaving a textured mesh surface on the outside of the balloon. The textured surface reduces balloon slippage inside a calcified lesion. The textured surface also helps anchor a stent during delivery before expansion. Additionally, by changing the size of the yarns, the surface texture can be altered. For example, every 5^{th} to 10^{th} yarn could be replaced with a larger yarn. This would reduce fabric bulk and increase fabric texture/roughness.

Large protrusions on the balloons surface, such as is seen in FIG. 20, could also be used to help “cut” or break highly calcified lesions. The large protrusions may be made by incorporating large diameter yarns/wires into the fabric surface during the textile manufacturing process. The yarns could be axial or radially placed. Radially placed at some predetermined pitch could help reduce balloon stiffness and crossing profile.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A material, useable in making inflatable medical devices, comprising:
at least one substantially circumferential fiber constructed and arranged to form a substantially cylindrical shape;
a fluid tight membrane, operably attached to said at least one substantially circumferential fiber, such that a lumen having at least one open end is defined by said membrane, said open end useable to introduce fluid into said lumen;
whereby said at least one circumferential fibers are constructed and arranged such that when said material is subjected to pressure, said material exhibits compliance until a predetermined first pressure is achieved, non-compliance during a predetermined range of said pressure, above said first pressure and ending at a second pressure, and return to compliant expansion after said second pressure had been exceeded.

2. The material of claim 1 wherein said at least one substantially circumferential fiber comprises a fiber arranged to form a spiral having a predetermined pitch.

3. The material of claim 1 wherein said at least one circumferential fiber comprises a plurality of circumferential fibers having at least two predetermined lengths, thereby forming a first set of fibers having a first length and at least one other set of fibers having a length longer than the first set, said fibers constructed and arranged circumferentially such that, during inflation, said material exhibits compliance until said predetermined first pressure is achieved, said first pressure coinciding with said first set of fibers becoming taut, said fibers thus preventing further compliant expansion as pressure continues to increase until said second pressure is achieved, said first set of fibers breaking when said second pressure is exceeded, thereby allowing said material to return to compliant expansion until said other set of fibers become taut.

4. The material of claim 1 wherein said at least one circumferential fiber comprises a plurality of circumferential fibers having at least two predetermined yield points, thereby forming a first set of fibers having a first yield point and at least one other set of fibers having a yield point greater than that of the first set, said fibers constructed and arranged circumferentially such that, during inflation, said material exhibits compliance until said predetermined first pressure is achieved, said first pressure coinciding with said first set of fibers reaching the first yield point, said fibers thus preventing further compliant expansion as pressure continues to increase until said second pressure is achieved, said first set of fibers breaking when said second pressure is exceeded, thereby allowing said material to return to compliant expansion until said other set of fibers their yield point.

5. The material of claim 1 wherein said membrane is radiopaque.

6. The material of claim 1 wherein at least one of said fibers is radiopaque.

7. The material of claim 1 wherein said membrane comprises a polymer placed within interstices of said at least circumferential fiber.

8. The material of claim 1 further comprising a plurality of longitudinal fibers operably attached to said membrane.

9. The material of claim 8 wherein said plurality of longitudinal fibers comprise a plurality of hollow, selectively inflatable longitudinal fibers constructed and arranged to lengthen when inflated such that they are useable to create controllable bends in said material, thereby making the material steerable.

10. The material of claim 9 wherein said plurality of longitudinal fibers are biased toward being straight when deflated, such that a predetermined retroflex force occurs upon deflating said fibers.

11. The material of claim 1 wherein said at least one circumferential fiber has a circular cross section.

12. The material of claim 1 wherein said at least one circumferential fiber has a substantially flat cross section.

13. The material of claim 1 wherein said at least one circumferential fiber has an oval cross section.

14. A steerable medical device comprising:
a plurality of hollow, selectively inflatable longitudinal fibers constructed and arranged to lengthen when inflated;
a fluid tight membrane, operably attached to said longitudinal fibers such that a lumen having at least one open end is defined by said membrane, said open end useable to introduce fluid into said lumen;
whereby said selectively inflatable fibers are useable to create controllable bends in said device such that said device is steerable.

15. The device of claim 14 further comprising at least one substantially circumferential fiber constructed and arranged to form a substantially cylindrical shape with the longitudinal fibers.

16. The device of claim 15 wherein said circumferential fiber spirals around the circumference of the device at a pitch preselected to provide a desired degree of flexibility.

17. The device of claim 14 further comprising a basket extending longitudinally from a distal end of said device, constructed and arranged to penetrate targeted tissue, such as arterial plaque, when said device expands longitudinally, and further constructed and arranged to capture dislodged particles of the targeted tissue so that the tissue is removed with the device.

18. The device of claim 14 wherein at least one fiber is radiopaque.

19. A catheter of a predetermined length, and having a distal end and a proximal end, comprising:
a plurality of longitudinal fibers;
at least one substantially circumferential fiber interwoven with said longitudinal fibers to form a substantially cylindrical mesh, the mesh having a weave density proportional to the number of circumferential fibers and the number of longitudinal fibers per unit area;
a fluid tight membrane of a predetermined thickness, operably attached to said longitudinal fibers and said at least one substantially circumferential fiber, such that a lumen having at least one open end is defined by said membrane, said open end useable to introduce fluid into said lumen
whereby said at least one substantially circumferential fiber forms a spiral down the length of the catheter having a predetermined pitch.

20. The catheter of claim 19 further comprising segments of increased flexibility in relation to other segments of the catheter.

21. The catheter of claim 20 wherein said increased flexibility results from decreased weave density.

22. The catheter of claim 21 wherein said decreased weave density is characterized by an increased pitch in relation to the predetermined pitch of the at least one substantially circumferential fiber in other segments of the catheter.

23. The catheter of claim 20 wherein said segments of increased flexibility result from a decreased membrane thickness in relation to the predetermined thickness of the membrane in other segments of the catheter.

24. The catheter of claim 19 wherein further comprising a segment at the distal end having a decreased membrane thickness in relation to the predetermined thickness of the membrane in other segments of the catheter.

25. The catheter of claim 24 wherein said segment at the distal end is permeable, thereby allowing fluid introduced to exit the lumen through said membrane.

26. A device comprising:
a plurality of longitudinal fibers;
a plurality of circumferential fibers interwoven with said longitudinal fibers;
a membrane at least partially engulfing said longitudinal and circumferential fibers such that a lumen is created with at least a portion of said membrane being fluid tight;
whereby at least one of said fibers protrudes radially from said membrane to form an external mesh arrangement.

27. The device of claim 26 whereby the membrane comprises a closed distal end.

28. The device of claim 27 whereby the membrane is inflatable, thus forming a balloon.

29. The device of claim 26 whereby said external mesh arrangement comprises a filter radially surrounding and relatively concentric with said membrane.

30. The device of claim 26 whereby said external mesh arrangement extends distally from said membrane thereby forming a cage at a distal end of said device.
